(19) United States
(12) Patent Application Publication
(10) Pub. No.: US 2009/0114713 A1
(43) Pub. Date: May 7, 2009

(54) Systems and Methods for Tracking Chemicals, Dispensing Chemicals, and Preparing Chemical Compositions

(75) Inventors: John Spenik, Phoenix, AZ (US); Brian Woodbury, Gilbert, AZ (US); Roc Lastinger, Cave Creek, AZ (US)

Correspondence Address: LETHAM LAW FIRM, LLC, 914 N. TUCANA LANE, GILBERT, AZ, 85234, US

(73) Assignee: Quixcode LLC, Scottsdale, AZ (US)

(21) Appl. No.: 12/348,060

(22) Filed: Jan. 2, 2009

Related U.S. Application Data
(63) Continuation-in-part of application No. 12/027,235, filed on Feb. 6, 2008.
(60) Provisional application No. 60/900,143, filed on Feb. 8, 2007.
(60) Provisional application No. 60/905,522, filed on Mar. 7, 2007.
(60) Provisional application No. 60/943,098, filed on Jun. 11, 2007.
(60) Provisional application No. 60/968,400, filed on Aug. 28, 2007.
(60) Provisional application No. 61/019,127, filed on Jan. 4, 2008.

(51) Int. Cl. G06F 19/00

(52) U.S. Cl. 235/375

(57) ABSTRACT

A method, according to various aspects of the present invention, for preparing a chemical composition. An apparatus that prepares chemical compositions performs the method. The method includes in any practical order: (a) electrically coupling to a first electrical conductor of a first data carrier; (b) receiving via the first conductor indicia of a property of a chemical; (c) electrically coupling to a second electrical conductor of a second data carrier; (d) receiving via the second conductor a formula for the chemical composition; and (e) detecting whether the property of the chemical is suitable for preparing the chemical composition. The first data carrier is mounted to a container that contains the chemical. The first data carrier stores indicia of the property of the chemical. The second data carrier is mounted to an object.

### CROSS-REFERENCE TO RELATED APPLICATIONS

This application is a continuation-in-part under 35 U.S.C. § 120 of U.S. application Ser. No. 12/027,235 filed Feb. 6, 2008 which claims the benefit under 35 U.S.C. § 119(e) of U.S. Provisional Application No. 60/900,143 filed Feb. 8, 2007, U.S. Provisional Application No. 60/905,522 filed Mar. 7, 2007, U.S. Provisional Application No. 60/943,098 filed Jun. 11, 2007, U.S. Provisional Application No. 60/968,400 filed Aug. 28, 2007, and U.S. Provisional Application No. 61/019,127 filed Jan. 4, 2008. All above applications are herein incorporated by reference.

### FIELD OF THE INVENTION

Implementations of the present invention relate to systems and methods for identifying, tracking, monitoring, and/or providing information regarding chemicals, containers of chemicals, formulas (e.g., recipes) for mixing chemicals, preparing chemical compositions, reducing improper preparation of chemical compositions, and dispensing controlled chemicals.

### BACKGROUND OF THE INVENTION

Industries involved in distribution of chemicals, preparation of chemical compositions, sale of chemicals and/or chemical compositions, recycling of chemicals, chemical compositions and/or containers used for the distribution and sale of chemicals may benefit from a system that, inter alia, tracks chemical containers and formulas for chemical compositions, improves the accuracy and control of preparing chemical compositions, facilitates recycling of used containers of chemicals by distributors that did not originally sell the container of chemicals, and distributes controlled chemicals.

### SUMMARY OF THE INVENTION

A method, according to various aspects of the present invention, for preparing a chemical composition. An apparatus that prepares chemical compositions performs the method. The method includes in any practical order: (a) electrically coupling to a first electrical conductor of a first data carrier; (b) receiving via the first conductor indicia of a property of a chemical; (c) electrically coupling to a second electrical conductor of a second data carrier; (d) receiving via the second conductor a formula for the chemical composition; and (e) detecting whether the property of the chemical is suitable for preparing the chemical composition. The first data carrier is mounted to a container that contains the chemical. The first data carrier stores indicia of the property of the chemical. The second data carrier is mounted to an object.

A method, according to various aspects of the present invention, for providing colorants to a container containing a base paint. A tinting device performs the method. The method includes in any practical order: (a) electrically and physically coupling to the container to receive a first information about the base paint; (b) receiving a second information about a formula for preparing a paint color; (c) detecting whether the first information corresponds to the second information; (d) in accordance with detecting, providing zero or more colorants to the container.

A tinting device, according to various aspects of the present invention, for tinting a base paint. The tinting device cooperates with a provided container that contains the base paint and a provided color card to tint the base paint. The tinting device includes a first electrical connector, a second electrical connector, and a processing circuit. The first connector electrically couples to a first provided conductor mounted to the container. The second connector electrically couples to a second provided conductor mounted to the color card. The processing circuit receives indicia of a property of the base paint from the container via the first conductor. The processing circuit receives indicia of a formula of a color from the color card via the second conductor. In accordance with the property of the base paint and the formula, the processing circuit provides a signal to a provided colorant dispenser to dispense zero or more colorants into the container.

A method, according to various aspects of the present invention, for providing a chemical to a container. The method performed by a dispensing device. The method includes in any practical order: (a) electrically and physically coupling to a data carrier mounted to the container, the container for receiving the chemical and the data carrier for providing a first information; (b) receiving a second information from a user; (c) detecting whether the first information corresponds to the second information; and (d) in accordance with detecting, dispensing the chemical into the container.

### BRIEF DESCRIPTION OF THE DRAWING

Embodiments of the present invention will now be further described with reference to the drawing, wherein like designations denote like elements, and:

FIG. 1 is a block diagram of a data carrier according to various aspects of the present invention;

FIG. 2 is a plan view of a memory map for the data carrier of FIG. 1;

FIG. 3 is a plan view of the data carrier of FIG. 1 mounted to a container;

FIG. 4 is another plan view of the data carrier of FIG. 1 mounted to a container;

FIG. 5 is another plan view of the data carrier of FIG. 1 mounted to a container;

FIG. 6 is plan view of the data carrier of FIG. 1 mounted to an object;

FIG. 7 is a block diagram of a preparation/dispensing system according to various aspects of the present invention;

FIG. 8 is a flow diagram of a method according to various aspects of the present invention for dispensing a chemical into a container;

FIG. 9 is a flow diagram of a method according to various aspects of the present invention for preparing a chemical composition;

FIG. 10 is a flow diagram of a method according to various aspects of the present invention for tinting a base paint;

FIG. 11 is a block diagram of a system for recycling containers and chemicals contained in containers according to various aspects of the present invention;

FIG. 12 is a flow diagram of a method performed by the system of FIG. 11 for determining whether to collect a container deposit; and

FIG. 13 is a plan view of a structure of the database of FIG. 1.

### DETAILED DESCRIPTION OF THE PREFERRED EMBODIMENTS

The term “pure” as used herein means a substance that is unmixed with any other thing.

The term “chemical” as used herein means a substance, whether pure or a combination of multiple substances. A chemical may exist in any state of matter (e.g., solid, liquid, gas). A chemical includes a base paint, a colorant, an ingredient of an alcoholic beverage, a drug.

The term “chemical composition” as used herein means a combination of chemicals. A chemical composition includes a combination of one chemical, whether pure or a combination of chemicals, with another chemical, whether pure or a combination of chemicals, to provide the chemical composition. A chemical composition may be formed according to a formula. A formula may specify proportions of various chemicals to form the chemical composition.

Chemicals (e.g., paint, prescription drugs, alcoholic beverages) are distributed and sold throughout the world in containers. At times, the container used to distribute one chemical accepts other chemicals to form a chemical composition in the container. Proper formation of the chemical composition depends on knowledge of the chemical in the container. The properties (e.g., composition) of a chemical in a container prior to mixing with other chemicals, may be displayed on the container (e.g., tag, label, barcode). An electronic device (e.g., data carrier) mounted to or associated with the container may also identify the composition of the chemical in the container. Knowledge of the properties of the chemical in the container prior to adding additional chemicals may be important to selecting the chemicals that are added to the chemical in the container. Knowledge of the properties of the chemical in the container may be necessary to form a desired chemical composition.

A container may also be selected (e.g., indicated, marked) for receiving a chemical only of a certain type (e.g., drug for human or animal use). In an environment where the content of the container may affect an outcome, identifying the target chemical for dispensing into the container may reduce the frequency of undesirable outcomes. Further, proper association of a specific container with a specific chemical may permit dispensing of controlled chemicals (e.g., prescription drugs, controlled substances) directly to consumers.

A vendor of chemicals may benefit from identifying chemicals in containers, identifying formulas for chemical compositions, and uniquely identifying containers. As set forth above, knowledge of the properties of a chemical in a container is beneficial while preparing chemical compositions. Accuracy in identifying a formula increases accuracy in finding a desire or necessary formula. Accuracy in identifying formulas may further permit greater control over use of the formula in circumstances where the developer of the formula desires to controls use of the formula. Additional knowledge of the chemicals required for a formula and knowledge of the properties of a chemical in a container increases accuracy in mixing chemical compositions. Uniquely identifying containers enables a vendor to track, monitor, and inventory containers and, as a result, chemicals in a container.

Chemicals (e.g., paint, gasoline, industrial substances, construction compounds) in a container may be toxic or may cause environmental damage if not disposed of properly. Furthermore, containers may be formed of materials suitable for recycling; however, container contact with a chemical may make it difficult to recycle the container through normal recycling channels. Uniquely identifying containers and providing methods for detecting the identity of containers may provide the basis of a method for encouraging proper disposal or recycling of containers and the chemicals stored therein.

The present invention eliminates the problems and makes possible the benefit described herein.

A device that prepares chemical compositions may receive information (e.g., knowledge, facts, data) from data carriers and other sources to prepare a chemical composition. The device may electrically couple to the conductors of a data carriers to receive information. A device may further couple to a network (e.g., local, internet) to receive information.

A data carrier may also uniquely identify a container. Unique identification of a container may provide a basis for dispensing a controlled substance (e.g., prescription drug) directly to a container (e.g., pill bottle) controlled by a consumer rather than a licensed dispenser (e.g., pharmacist). A unique container identifier may further provide the basis for collecting and distributing recycling fees and container deposits to motivate chemical and container users to recycle containers and chemicals.

Systems according to various aspects of the present invention receive, analyze and/or compare information, communicate information, store information, provide a signal for control of a process, take an action, decline to take an action, and/or provide a notice in accordance with information.

Systems according to various aspects of the present invention identify chemicals in a container; uniquely identify a container, identify a chemical presently stored in a container or formerly stored in a container; receive a formula of a chemical composition; determine whether the chemical in the container is suitable for a chemical composition; and prepare or not prepare the chemical composition in accordance with the suitability of the chemical for the chemical composition. Systems may electrically couple to data carriers mounted to objects to receive information, receive information through communication via a network, and store information in a database for local access.

Systems and methods according to various aspects of the present invention may be used to increase accuracy of chemical composition preparation; protect proprietary rights to a chemical, a formula, or a chemical composition; facilitate recycling of unused chemicals; facilitate recycling of empty chemical containers; and automate dispensing of chemicals or controlled chemicals or chemical compositions.

For example, a base paint is a chemical (e.g., substance, material) purchased in a container (e.g., can, bucket, barrel, bottle, aerosol dispenser) that may be mixed with other chemicals (e.g., colorants, anti-fungal, uv-coating, weather-proofing, temperature resilience, drying agent, texture, finish) to produce a chemical composition (e.g., paint) for use. Base paints may be colored (e.g., tinted) according to formulas. Paint manufacturers provide color formulas and samples (e.g., paint chips, color cards) that display the color of a paint mixed according to a formula. Consumers may evaluate the colors shown on a sample and purchase a base paint and colorants to achieve the color on the sample. Paint prepared in a mixing (e.g., coloring) process that does not meet the color expectations of the consumer may be rejected by the consumer. A mixed paint that does not meet the customer's color expectations is generally referred to as a mistint which is sold at a discount or disposed of as waste.

The properties and compositions of various base paints (e.g., from different manufacturers, different types) differ. A color formula may be developed for the properties (e.g., color, shade, type, sheen, finish) of a specific base paint. Tinting a base paint that does not have the chemical properties required by a formula may result in a color that is different from the color intended by the formula thereby resulting in a mistint. In particular, a manufacturer may develop color formulas or colorants for use with their own base paints. The formulas may provide the expected color (e.g., color on sample or color card) only when mixed with a base paint from the same manufacturer. Using a formula from one manufacturer with the base paint of another manufacture may result in a mistint.

In another example, some chemicals (e.g., prescription drugs, mixed alcoholic beverages) are sold in controlled environments or through controlled sales channels that discourage or prohibit sales methods that favor self-service by consumers. Systems according to various aspects of the present invention may be used to describe chemicals or chemical compositions, user information, payment information, number of permitted refills, and user authentication to permit dispensing of at least some controlled chemicals directly to consumers without assistance or interference at least as the point of dispensing.

Identifying a chemical includes receiving information about the chemical. Information about a chemical may include a scientific name, a description of its composition, a level of purity, a manufacturer identifier, a chemical property, a unique identifier (e.g., unique identification number), a physical attribute, and a date of manufacture.

Identifying a chemical in a container includes receiving information about the chemical in the container. Information about a chemical contained in a container may further include, in addition to the above information about the chemical, a unique identifier of the container (e.g., serial number), a fullness of the container, a chemical composition of the material that makes up the container, a data of manufacture of the container, a manufacturer identifier of the container, an origin of the container, a model type of the container, a prior use of the container, a permissible use (e.g., food, non-food) of the container, solvents that may affect the integrity of the container, a temperature range of safe use of the container, and a description of how to recycle the material of the container. Information that uniquely identifies a container may be used for tracking the container.

Receiving a formula includes receiving information about a chemical composition. A formula may include a description of a chemical composition, chemicals for use in the composition, alternate chemicals for use in the composition, instructions for making the composition, safety notices about the composition, instructions for disposal of the composition, toxicity of the composition, safe storage of the composition, chemical properties of the composition, physical attributes of the chemical composition, and proprietary rights that may apply to the composition.

Detecting whether a chemical is suitable for a chemical composition may include comparing information about the chemical to information about the chemical composition, detecting a common manufacturer of the chemical and the formula of the chemical composition, detecting a common manufacture of all or most of the chemicals used to make the chemical composition, detecting whether the chemical is required for the composition, detecting whether the chemical is impermissible in the composition, detecting whether a chemical property or a physical attribute of the chemical is appropriate for the formula, detecting whether the chemical will provide a desired outcome (e.g., color, correct drug), and detecting whether the chemical poses a safety risk in the composition.

Taking an action or performing an operation in accordance with the suitability of the chemical for a chemical composition may include taking an action or performing an operation (e.g., using the chemical according to a formula) conditioned upon the chemical being suitable for the composition or not taking the action or performing the operation conditioned upon the chemical not being suitable for the composition. Criteria for a chemical not being suitable for a chemical composition includes circumstances where a manufacture of the chemical is not the same as the manufacture of the formula for the chemical composition, use of the chemical in the composition may result in an undesirable result (e.g., mistint, illegal), and use of the chemical in the composition may result in a safety hazard (e.g., toxic mixture, excessive heat, explosion). An action or operation may include using a chemical in a composition and/or mixing two or more chemicals.

Increasing accuracy of preparing a chemical composition includes receiving information about a chemical, receiving a formula, receiving information about a chemical composition, and preparing the composition conditioned upon whether the chemical is suitable for the composition. An apparatus, according to various aspects of the present invention that prepares the composition or that receives the information for analysis of suitability may provide a notice upon detecting that a chemical is not suitable for the chemical composition.

A notice may include information about the chemical, information about a container containing the chemical, an identifier of the entity seeking to make the chemical composition, a location of the mixing apparatus, and information about the chemical composition including its formula and manufacturer that developed or distributes the formula.

A system that receives information about a chemical and/or a formula may protect any proprietary rights that may exist in the chemical or formula. Protecting proprietary rights to a chemical, a formula, or a chemical composition may include withholding information about a chemical, a formula, or a chemical composition from unauthorized parties; receiving information about a chemical, a formula, or a chemical composition; comparing information; detecting inconsistent information (e.g., chemical type does not match unique identifier of container, manufacturer of chemical is not the same as manufacture or distributor of formula); and not taking an action or performing an operation conditioned upon whether the right to control the chemical, the composition, or the formula are consistent or inconsistent.

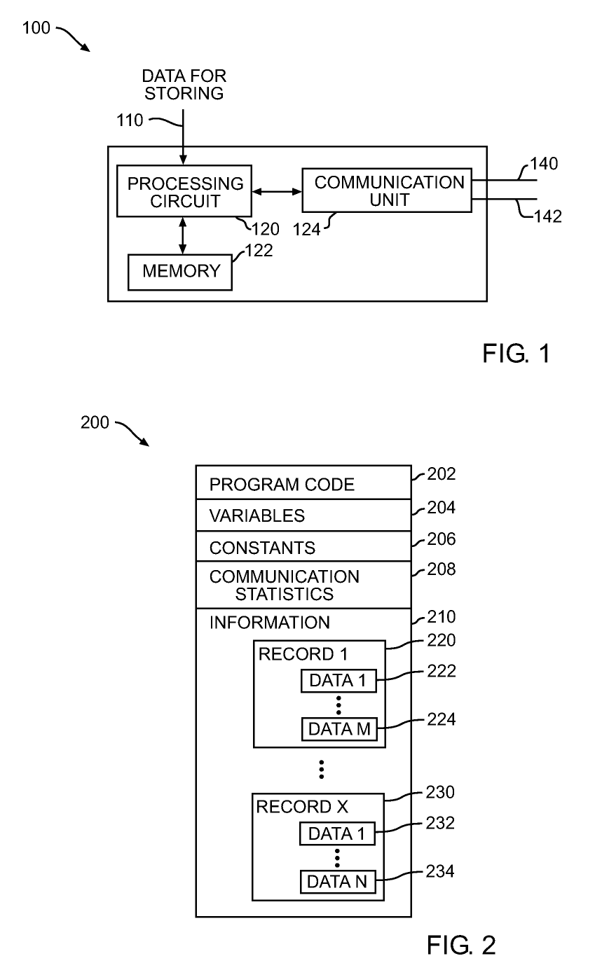

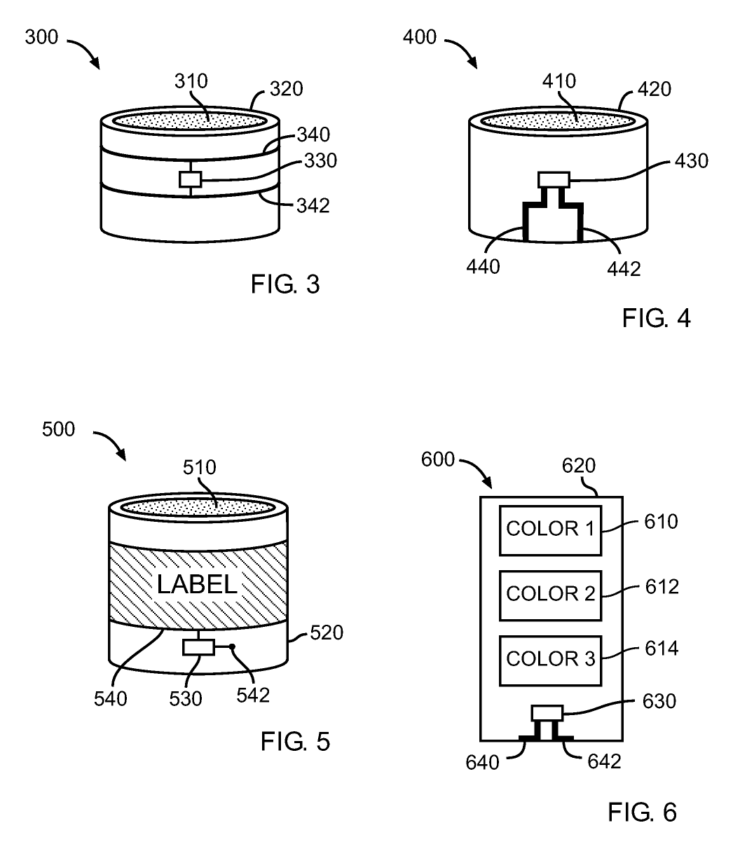

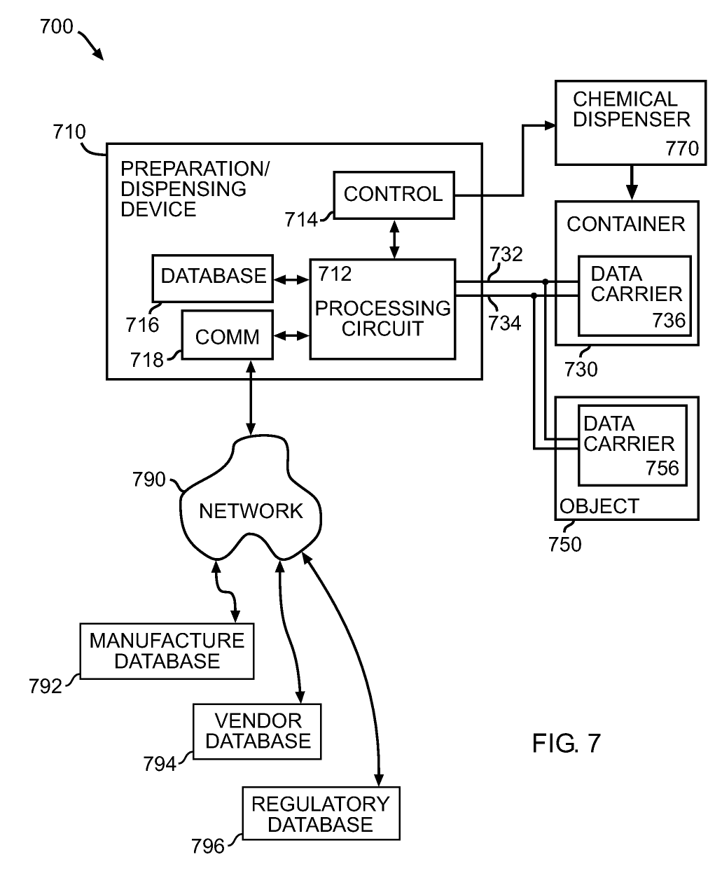

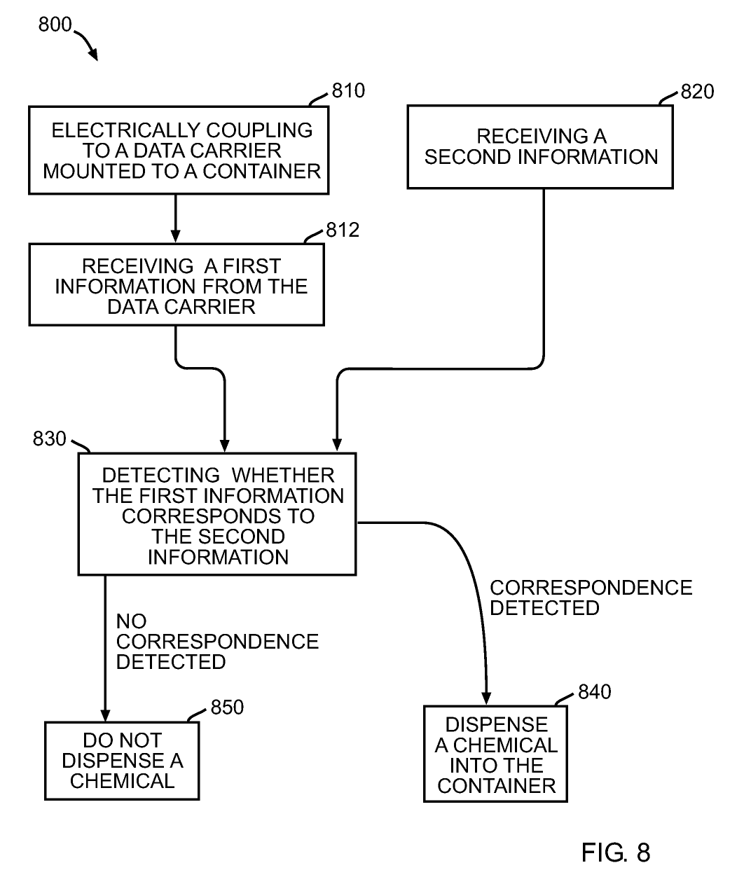

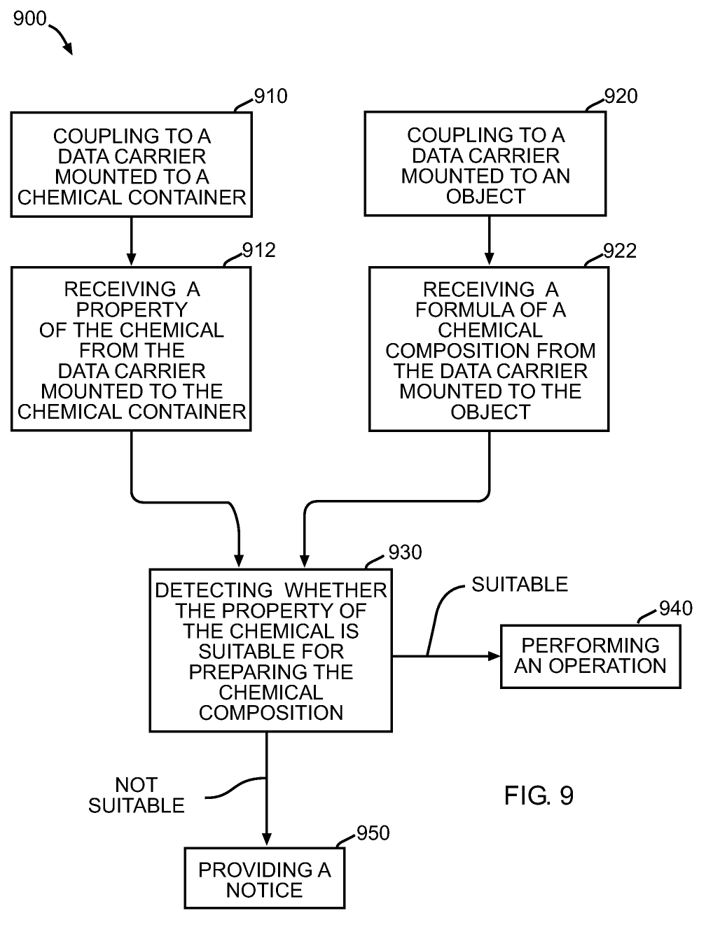

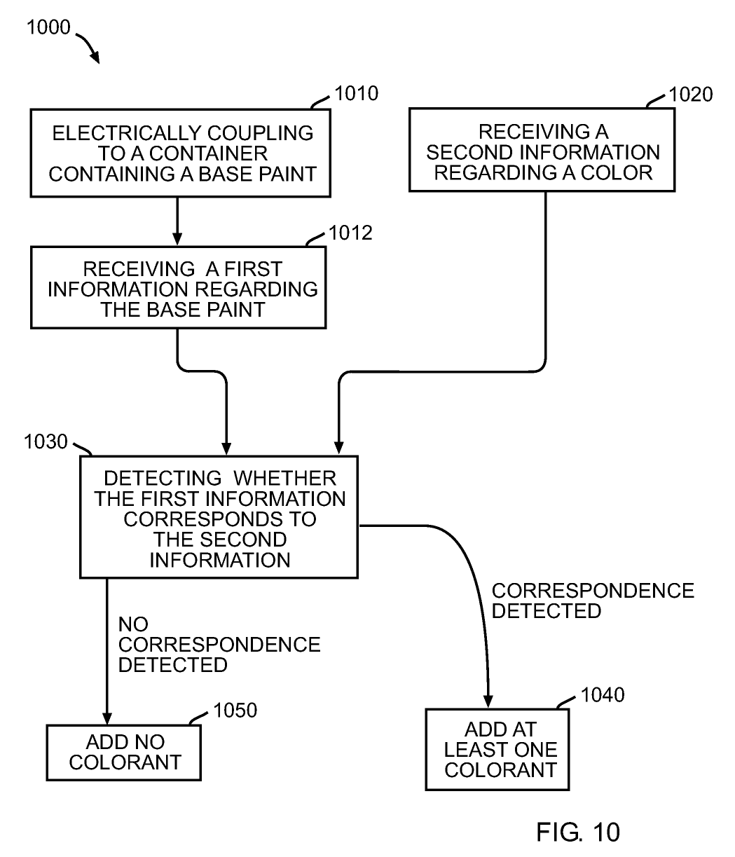

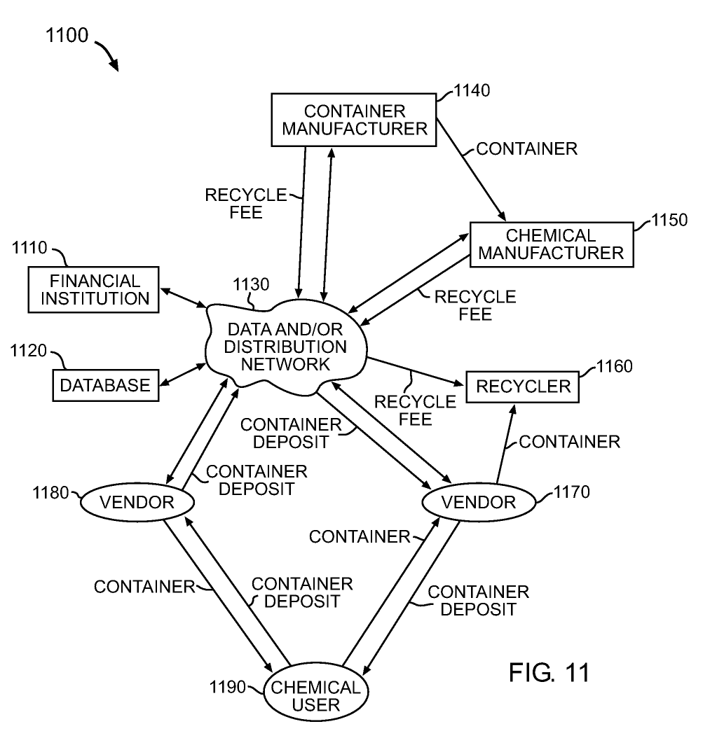

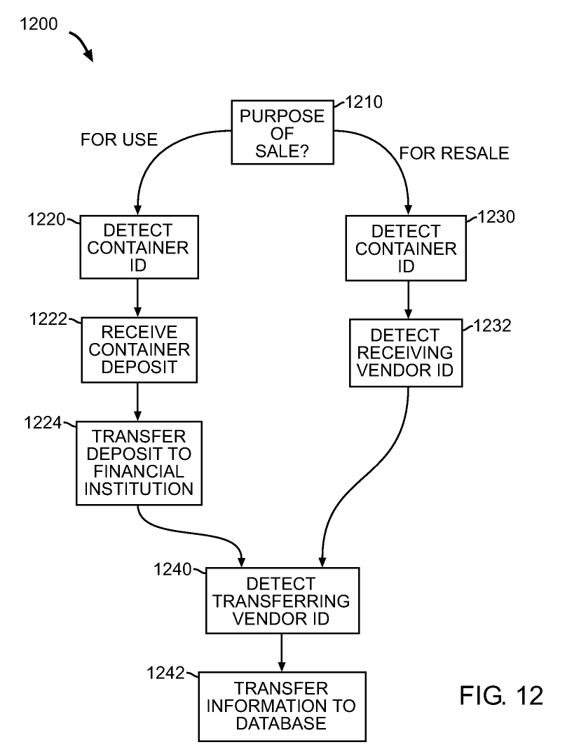

For example, systems 100, 300, 400, 500, 600, 700 and 1100 of FIGS. 1-13, according to various aspects of the present invention, store, provide, receive, analyze, communicate, organize and/or compare information; electrically and/or physically couple; control of a process; takes an action; decline to take an action; provide a notice; identify chemicals in a container; uniquely identify a container, identify a chemical presently stored in a container or formerly stored in a container; receive a formula of a chemical composition; determine whether the chemical in a container is suitable for a chemical composition; prepare or not prepare a chemical composition in accordance with the suitability of the chemical for the chemical composition; and facilitate recycling of container and/or chemicals.

A data carrier stores information and may provide indicia of the stored information. A data carrier (e.g., tag), for example system 100, may store, provide, receive, communicate and organize information. Information stored and provided by a data carrier includes any information that may be stored in a binary representation including properties of a chemical, permitted chemicals, a chemical formula, a manufacture identifier, and a unique identifier.

A data carrier may be associated with an object (e.g., container, formula card, insurance card). A data carrier that is associated with an object may store information about the object. Associating a data carrier with an object may include mechanically mounting (e.g., attaching, gluing, soldiering) the data carrier to the object. A data carrier may store information about the object to which it is mounted. In an implementation, a data carrier mounted to a container stores information that uniquely identifies the container (e.g., unique serial number). A data carrier may store information about objects to which the data carrier is not mounted. In an implementation, a data carrier is mounted to a container that contains a chemical. The data carrier stores information about the container and the chemical stored in the container. Information in a data carrier mounted to an object may be accessed to determine a property of the container or the chemical in the container.

A data carrier may be mounted on any object suitable for mounting. A data carrier may be mounted to an object to provide convenient handling (e.g., storage, display, transport, use) of the data carrier to provide information. An object may include a human detectable representation (e.g., writing, sound, scent, texture, visual display) of the information stored in the data carrier mounted to the object. In one implementation, a paint color card displays paint colors that may be achieved by mixing colorants with a base paint according to a formula. A human may see the paint colors. A data carrier mounted to the paint color card stores the formula for each color. Preparing a base paint according to the formula provides the color shown on the color card.

A data carrier may be of the type described in U.S. application Ser. No. 12/027,235 filed Feb. 6, 2008 as identified and incorporated by reference above. Receiving information from a data carrier of this type requires a reader to electrically couple to a conductor of the data carrier. Electrically coupling includes physical contact between the objects that electrically couple. A coupling may be releasable. A touching of two electrical conductors accomplishes electrical coupling. Thus, a reader physically contacts with at least one conductor of the data carrier to electrically couple the reader to the data carrier. A coupling between two conductors (e.g., antennas) via electromagnetic radiation (e.g., RF signal), but absent physical contact is not electrically coupling as used herein.

A conductor for accessing data from a data carrier of this type may be positioned on an object for contact with a reader. A reader may simultaneously contact the conductor of a plurality of data carriers to receive information from each data carrier without individually addressing each data carrier. The data carrier and reader of this type further enables receiving information from data carriers that are positioned in close physical proximity (e.g., immediately adjacent). An example of objects in close physical proximity includes color cards stacked upon each other or touching adjacent cards while on display. At times, objects that are in close physical proximity may not provide information to a reader via electromagnetic radiation, because adjacent objects interfere with the RF signal from any one RF transmitter or receiver. However, data carriers that electrically couple to a reader via a conductor but may provide information to the reader in spite of their close physical proximity.

For example, data carrier 100 may include interface 110, processing circuit 120, memory 122, communication unit 124, and conductors 140 and 142.

A processing circuit controls the operation of a data carrier. A processing circuit receives information, stores information, retrieves information from storage, and provides information to a communication unit. A processing circuit includes state machines, microprocessors that execute a stored program, data converters (e.g., ADC, DAC), and timers for maintaining time of day and/or detecting a lapse of time. In an implementation, processing circuit 100 includes a state machine that does not execute a stored program, but performs functions as dictated by the state machine. In another implementation, processing circuit 100 includes a conventional microprocessor that executes a stored program.

A memory stores information. A memory receives information for storage, provides information from storage. A memory may store information in an organized format. In an implementation, memory 122 includes a circuit that provides stored information in a sequential manner without receiving an address prior to providing the information. In another implementation, memory 122 includes a conventional mask-programmable ROM. In another implementation, memory 122 includes a conventional, non-volatile memory (e.g., EPROM, ROM, EEPROM) and/or a conventional volatile memory (e.g., RAM, DRAM, SRAM).

A processor may provide information to a memory for storage. A processor may receive information from a memory. A processor may perform a function in accordance with information received from a memory. A processor may provide information received from a memory to another functional block in a data carrier. A processor may organize information prior to storage in a memory. A memory may organize information receive from a memory for storage in the memory. A memory may store program code, variables, constants, communication statistics, and information.

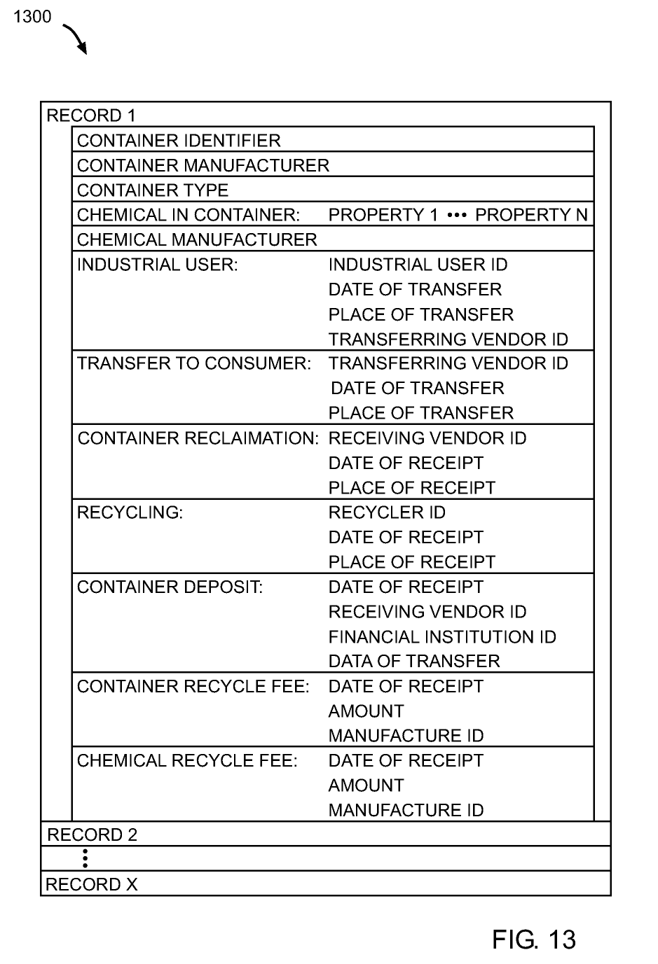

Information may be organized as a record. Information may include one or more records. Records may be organized (e.g., alphabetically, chronologically, size, priority, relevance, table, list, hierarchal, thematically, by subject) in any manner. A record may include data (e.g., fact, description, principle, formula, recipe, report, analysis). Data may be organized in any manner. A record may include data about anything including data about an object (e.g., container), a formula, a chemical, a chemical composition, a manufacturer, and an identifier. Information may include any data of the type shown in Record 1 of FIG. 13 and/or any information or data disclosed herein.

In an implementation, memory 122 stores program code 202 (e.g., for execution by a processor), variables 204, constants 206, communication statistics 208, and information 210. Information 210 may include one or more records such as record 220 and 230. A record may include data. Each record may include data that is different from data stored in any other record. For example, record 220 stores data 22 and 224 while record 230 stores data 232 and 234.

A processing circuit may receive information for storing via an interface. An interface may include any conventional data bus (e.g., I2C, USB, SPI) or proprietary bus. An interface may be asynchronous or synchronous. Information provided via an interface may be provided in a known order without identifiers or in any order and at any time with identifiers that identify the information provided via the interface. A processing circuit may use an information identifier to store information in a memory (e.g., at a particular address).

A communication unit provides information via conductors 140 and 142. A communication unit electrically couples to conductors 140 and 142. A communication unit communicates using a communication protocol. A communication protocol includes a proprietary protocol and any conventional protocol (e.g., I2C, USB, IEEE 1394). A communication unit may receive information for communicating from any source. A communication unit may receive information for communicating from a processing circuit or a memory.

A communication unit provides information via conductors 140 and 142 without being individually enabled or addressed. In an implementation, a reader electrically couples to conductors 140 and 142. The reader provides a ground signal to conductor 142 and a power signal to conductor 140. Data carrier 100 uses the power provided by the reader to perform functions of the data carrier. Upon receiving power, processor 120 retrieves information from memory 122 and provides the information to communication unit 124. The reader does not provide an enable signal or an address for decoding by data carrier 100 to enable data carrier 100 to provide data via conductors 140 and 142.

A reader may couple in parallel to conductors 140 and 142 respectively of more than two data carriers 100 and receive information from each data carrier 100 without individually enabling and/or addressing each data carrier 100. A first data carrier that is coupled in parallel to a second data carrier may detect that the second data carrier is providing information via conductor 140. The first data carrier may cease providing (e.g., back-off) information for a period of time (e.g., random, fixed) to reduce collisions of data from more than one data carrier.

In an implementation, communication unit 124 provides information stored by memory 122 via conductors 140 and 142. One conductor (e.g., 142) provides a common signal (e.g., ground) while the other conductor (e.g., 140) provides the information. A reader (not shown) electrically couples to conductors 140 and 142. The reader provides a signal (e.g., power, VCC, VDD, sine wave) on conductor 140. Communication unit 124 receives data from processing circuit 120. Communication unit 124 modulates the signal received from the reader in accordance with the data received from processing circuit 120. The reader detects the modulated signal and demodulates the signal to receive the data.

More than two or more data carriers coupled to a reader may receive the signal provided on conductor 140. Upon receiving the signal on conductor 140, each data carrier begins to provide data without being addressed (e.g., selected, enabled) by the reader. Each data carrier may modulate the signal in accordance with the data stored in each respective data carrier. The reader may receive, demodulate and detect the data provided by each data carrier. Each data carrier may detect when another data carrier is modulating the signal provided by the reader and may back-off to increase the probability that only one data carrier is modulating the signal from the reader at any one time.

Modulation of a signal from a reader includes any conventional modulation (e.g., AM, SSB, FM, PM, SM, FSK, ASK, PSK, QAM, DSSS). In an implementation, communication unit 124 receives a DC power signal on conductor 140 and a ground signal on conductor 142. Communication unit 124 modulates an amplitude of the power signal on conductor 140 by reducing an impedance between conductor 140 and 142 (e.g., shorting). A voltage amplitude and/or a transition of the signal on conductor 140 corresponds to a value of the data provided.

As described above, a data carrier may mount to a container and may store information about the container and a chemical contained in the container. A data carrier may also mount to a color card and store information about a tinting formula for producing the colors show on the color card. Conductors may also be mounted on a container to facilitate electrical coupling to the data carrier. Conductors mounted on the container or object electrically couple to conductors 140 and 142 of data carrier 100.

In an implementation, data carriers 330, 430 and 530 mount to respective containers 320, 420, and 520. Container system 300 includes conductors 340 and 342 that electrically couple to the conductors (e.g., 140, 142) of data carrier 330. Conductors 340 and 342 encircle container 320 thereby permitting electrical coupling of a reader to data carrier 330 regardless of the radial orientation of can 320.

A conductor includes any material that conducts electricity. A conductor may electrically and/or mechanically couple to another conductor. A conductor includes a wire (e.g., 340, 342), foil, a conductive label (e.g., 540), a metallic container (e.g., 520), conductive ink (e.g., 440, 442), and conductive paint.

A reader (not shown) may electrically couple to conductors mounted to a container to receive information from the data carrier mounted to the container. A reader may electrically couple to more than one container to receive information from the data carrier mounted to each container as describe above with respect to receiving information from more than one data carrier. A shape of a container may protect a conductor from damage. A conductor may be positioned in an opening, groove, or slot of a container to protect the conductor. A conductor may be position in a cavity of the container. A cavity may include a moveable covering to further protect the conductor.

In an implementation, a conductor is positioned in a cavity of a container. A moveable door or membrane covers the cavity. A conductor of a reader moves the door to an open position or penetrates the membrane to electrically couple to the conductor in the cavity. Withdrawing the conductor of the reader permits the door to close or the membrane to seal thereby protecting the conductor in the cavity.

In an implementation, container system 400 includes conductors 440 and 442 mounted to container 420. Positioning container 420 in such a manner that conductors 440 and 442 electrically couple to a reader enables the reader to receive information stored in data carrier 430. Container system 500 includes conductive label 540 that encircles container 540 and electrically couples to data carrier 530. Container 520 is formed of a conductive material (e.g., metal). Conductor 542 of data carrier 530 electrically couples to can 520. A reader may electrically couple to conductive label 540 and any portion of container 520 not covered by label 540 to receive information from data carrier 530. Label 540 and container 520 are not electrically coupled thereby forming two conductors to provide information from data carrier 530.

A container includes any type of container made of any type of material or combination of materials that is suitable for its containing function. A container may have any shape. The shape of a container may cooperate with a reader or other device (e.g., keyed) to position conductors of a data carrier mounted to the container for electrical coupling.

A container may contain an object (e.g., a chemical). As set forth above a data carrier may store information about the container and/or the object contained in the container. For example, containers 320, 420, and 520 each contain chemical 310, 410, and 510 respectively. Containers 320, 420, and 520 are formed of materials suitable for containing their respective chemicals. Data carriers 330, 430, and 530 may store information about the respective carrier to which each data carrier is mounted. Information about the container may include a manufacturer identifier, a manufacture date, a container material (e.g., ingredients), a date of filling the container, a method for recycling the container, an expiration date of the container.

Data carriers 330, 430, and 530 may store information about chemicals 310, 410, and 510 respectively stored in containers 320, 420, and 520 respectively. Information about a chemical may include a property of the chemical, a composition of the chemical, a date of manufacture, a manufacturer identifier, an expiration date, a weight by volume, a toxicity, a method for recycling, a temperature range (e.g., storage, use) of the chemical, a number of permitted refills of the container, a prescribing doctor, an industry trade name of the chemical, and a chemical vendor identifier.

In an implementation, chemicals 310, 410, and 510 include a base paint. Data carrier 330, 430, and 530 respectively store information about the base paint including a manufacture identifier, manufacture date, base paint type (e.g., water-base, oil base), sheen (e.g., gloss, semi-gloss, eggshell, satin, flat), temperature range (e.g., storage, application, drying, curing), times related to use (e.g., application, drying, curing), durability (e.g., interior, exterior), permissible additives (e.g., anti-fungal, anti-mildew, drying agent, colorant, pigment, binder, anti-oxidant, surfactant), non-permissible additives, permissible solvents (e.g., water, acetone, turpentine, naphtha, toluene, xylene, methyl ethyl ketone), viscosity (liquid, liquefiable, mastic, granular), preparation, toxicity, and an expiration date.

In an implementation, chemicals 310, 410, and 510 include a prescription drug. Data carrier 330, 430, and 530 respectively store information about the prescription drug including a manufacture identifier, a manufacture date, dosage, temperature range (e.g., storage), toxicity, an expiration date, prescribing doctor, number of refills permitted for the container, number of refills remaining, side effects, method of use (e.g., with food, with water, topical application), cautions, allergy warnings, strength (e.g., potency), and active ingredient.

Color card 600 includes object 620, color samples 610-614, data carrier 630 and conductors 640 and 642. An object provides a base for mounting color samples, a data carrier, and conductors. An object may be of any size, shape, or material. In an implementation, object 620 includes cardstock (e.g., paper, plastic). Cardstock may be of any thickness, size, shape, material, and/or color. Color samples 610-614, data carrier 630 and conductors 640-642 mount to cardstock 620.

In an implementation, color card 600 provides a display of colors that may be prepared by mixing a base paint with conventional colorants according to a respective formula. Colors may be viewed by a human or used for machine comparison to match colors. Data carrier 630 stores information about color samples 610-614. Information stored by data carrier 630 may include color name, color identifier, pantone color number, a respective formula for mixing a base paint to achieve each color 610-614, formula manufacturer identifier, colorant manufacturer identifier, acceptable substitutions (e.g., base paint, colorants), proprietary rights (e.g., patent, trademark, copyright, common law), owner of proprietary rights, base paint properties for acceptable result, undesirable base paint properties, date of first issue of color, color family, acceptable surfaces for receiving mixed paint, acceptable surface texture, complementary colors, a unique color card identifier, a unique color sample identifier for each color 610-614.

Object 620 may have a shape and size suitable for display for consumer viewing and positioning for electrical coupling to provide/receive information. Conductors 640 and 642 may be positioned to permit receipt of information from each data carrier 630 of each respective sample card 600 while positioned for display, while positioned for storage, and/or prior to positioning for display. In an implementation, sample card 600 is substantially rectangular and rests in a tray of a display in such a manner that a paint consumer may see at least color 610 while sample card 600 is on display. Sample card 600 further includes conductors 640 and 642 at a bottom portion of sample card 600 so that a reader (not shown) may contact each card of a plurality of cards in a tray of the display. Because a reader may electrically couple to one or more data carriers 630 and receive information from each respective data carrier, the reader may electrically couple to many sample cards 600 on display and may receive information from the data carrier 630 of each sample card 600. Information from each sample card may be used to inventory the number and type of cards on display.

Containers and/or objects having data carriers may be used to prepare chemical compositions. A chemical composition preparation device may receive information about a property of a chemical in a container and a formula of a chemical composition. The preparation device may use the information and formula to dispense additional chemicals into the container to form the chemical composition.

Containers and/or objects having data carriers may be used to dispense a chemical into a container. A chemical dispensing device may receive information about a chemical that may be dispensed into a container. The device may further receive payment information, identity information about the chemical recipient, and/or authorization information. The dispensing device may use the information to dispense a chemical into the container.

A chemical preparation/dispensing device (e.g., preparation device, dispensing device, device), according to various aspects of the present invention, receives, analyzes and/or compares information; communicates information; stores information; provides a signal for control of a process; takes an action; declines to take an action; and/or provides a notice in accordance with information.

A chemical preparation/dispensing device, according to various aspects of the present invention, may communicate (e.g., send, receive), inter alia, information about a container, a chemical in a container, a unique identifier of a container, a unique identifier of a chemical in a container, a formula for a chemical composition, a prescription drug, an identity of a receiver of a prescription drug, and any other type of information disclosed herein. A chemical preparation/dispensing device may determine whether a chemical in the container is suitable for a chemical composition or whether a container is suitable for receiving a chemical. A chemical preparation device may prepare or not prepare a chemical composition in accordance with the suitability of a chemical (e.g., in container, colorant) for the chemical composition. A chemical dispensing device may dispense or not dispense a chemical in accordance with the suitability of the container and/or recipient to receive the chemical.

A chemical preparation/dispensing device, according to various aspects of the present invention, may increase accuracy of chemical composition preparation; protect proprietary rights to a chemical, a formula, or a chemical composition; and automate dispensing of chemicals, controlled substances or chemical compositions in a consumer environment. A chemical preparation/dispensing device may electrically couple to data carriers, receive information through communication via a network, and store information for local access. A data carrier that provides information to a chemical preparation/dispensing device may be mounted to an object. Conductors from the device may electrically couple with conductors on the object to receive the information as described above.

For example, preparation/dispensing system 700 includes preparation/dispensing device 710, chemical dispenser 770, and container 730. System 700 may further include object 750, network 790 and databases 792, 794, and 796.

Preparation/dispensing device 710 includes processing circuit 712, control 714, database 716, and communication unit 718. A processing circuit controls the functions of device 710. A processing circuit receives information, provides information, compares information, determines suitability of information for taking or not taking an action, and controls chemical dispensing. A processing circuit may electrically couple, directly or indirectly, to one or more data carriers to receive information from the data carrier.

A control operates to dispense a chemical. A control cooperates with a processing circuit and a chemical dispenser to dispense a chemical. A control may cooperate to dispense a chemical in a container.

A communication unit communicates information. A communication unit may send and/or receive information via a network. A communication unit may provide information to a processing circuit and receive information from a processing circuit. Information sent or received by a communication unit may be stored in or retrieved from a database and/or a data carrier.

A database stores information. A processing circuit may store information in a database and receive information from a database. Information in a database may be stored and/or organized in any manner. A database may be implemented using a conventional database management system (e.g., Oracle, dBase, SQL, MySQL, Microsoft SQL server, Microsoft Access, Microsoft Visual FoxPro, OpenVMS, MyOODB, XML). A database may include any conventional hardware and/or software to implement the database. A database may store any or all the information described herein.

A database may be accessed and used via a local connection (e.g., database 716) or via a network (e.g., databases 792, 794, 796). A network includes any conventional network (e.g., local, internet, 3G cell, pager, proprietary, wireless). Any conventional communication protocol (e.g., SMS, IEEE 802.11, TCP/IP, USB, IEEE 1394) may be used to communicate via a network.

Information may be stored in one or a plurality of databases. A database may contain information selected for a particular use. A manufacture database may include information about the manufacture and sale of goods. A vendor database may include information about purchase, inventory, preparation, and sale of goods. A regulatory database may include information about the source, use, and disposition of goods. A regulatory database may be used to track movement of goods through industry and eventual recycling of goods. A unified database may be maintained having all or part of the information of primary interest to a manufacture, a vendor, or a regulatory agency. A combined database may be used by manufacturers, vendors, regulators, or any combination thereof to track the manufacture, preparation, sale, use, and final disposition of goods.

For example, manufacture database 792 may store information of interest to a manufacturer including date of manufacture, manufacturer identifier, manufactured object identifier, date of sale, sale price, cost of goods, buyer identifier, quality verification information (e.g., inspection, testing), object composition, object properties, expiration date, chemical composition, recycling fees paid, date recycling fee paid, amount of recycling fee, and identifier of recipient (e.g., financial institution holding fee) of recycling fee.

Vendor database 794 may include information of interest to a vendor of goods such as date of purchase, date of sale, sales person identifier, incoming inspection information, sale price, purchase price, manufactured goods identifier, manufacturer identifier, warranty information, purchaser identifier, method of payment, deposit information (e.g., container deposit), amount of deposit, date of receipt of deposit, identifier of recipient of deposit fee, formula used to prepare a chemical composition for a purchaser (e.g., tinting of paint), whether purchaser was end-user or reseller, and chemical composition prepared with manufactured goods.

Regulatory database 796 may include information of interest to a regulatory body responsible for the regulation of a manufactured good. For example, the Federal Drug Administration may have an interest or responsibility for regulating the use of prescription drugs. The Environmental Protection Agency may have an interest or responsibility for regulating the proper disposal of chemicals. Information in a regulatory database may include manufacturer identifiers, unique product identifiers, chemical compositions prepared, chain of custody (e.g., identifiers of purchasers/sellers), end-user identifier, recycling fees paid, recycling fees disbursed, deposit fees paid, deposit fees disbursed, verification of recycling, recycler identifier, and identifier of financial institution holding deposit or recycling fees.

Information in a database may be organized as one or more records. A record may contain information and/or data related to a container, chemicals stored in the container, and chemical compositions formed in the container. A record may pertain to a single container or to related containers. A record may be uniquely identified by a unique container identifier. For example, database 1300 includes one or more records. Each record contains data about one container. Each record identifies the container for which the data belongs using a unique container identifier. A database may include all or part of the information shown for record 1 of database 1300. A record may include any of the information set forth herein.

In an implementation, preparation system 700 includes preparation device 710, chemical dispenser 770, container 730, and object 750. Container 730 contains a base paint. Data carrier 736 is mounted to container 730 and stores information about the container and the base paint. Object 750 displays information about paint colors (e.g., color card). Data carrier 756 is mounted to object 750 and stores information about the formula to create each color displayed on object 750. Chemical dispenser 770 includes colorants (e.g., tints) for tinting the base paint in container 730 according to one of the formulas for the colors displayed by object 750.

Preparation system 700 may use any method for receiving information and tinting the paint contained in container 730. In one implementation, preparation system 700 performs method 900 to receive information and prepare the base paint of container 730. Method 900 includes processes 910 through 950.

In preparing a base paint, preparation device 710 performs process 910 by electrically coupling to data carrier 736, which is mounted on container 730. Electrical coupling is accomplished by physically and electrically coupling conductor 732 and 734 of preparation device 710 to the respective conductors of container 730 and data carrier 736. Preparation device 710 performs process 920 by electrically coupling conductors 732 and 734 to the electrical conductors of object 750 and data carrier 756. Because more than one data carrier may electrically couple in parallel and still provide their respective information, preparation device 710 may electrically couple and receive information from two or more data carriers via conductors 732 and 734. Preparation device 710 may further included additional conductors to electrically couple with other containers or objects.

Via the electrical coupling of conductors, preparation device 710 performs processes 912 and 922 to receive information from data carrier 736 about the base paint contained in container 730 and from data carrier 756 about the formulas for tinting the base paint.

Preparation device 710 performs process 930 to use the information received from data carriers 736 and 756 to determine whether the base paint in container 730 is suitable for the formulas received from data carrier 756. Any criteria may be used to determine suitability including those set forth above. A test for suitability may include several criteria all of which must be present for the base paint to be suitable for the formula. For example, a base paint may be suitable for a formula only if the base paint and the formula are produced by the same manufacturer and the color of the base paint will accurately produce the desired color. Additional criteria may include whether the properties of the base paint (e.g., paint type, sheen, temperature range, durability and permissible additives, impermissible additives, viscosity) will provide the desire outcome of the formula.

If the properties of the base paint are found to be suitable for the formula, processing circuit 712 performs process 940 to perform a function. A function includes dispensing a colorant into the base paint of container 730 according to the formula, issuing a command to control 714 to control an apparatus (e.g., chemical dispenser 770, paint shaker), communicating with database 716, and communicating with a database via communication unit 718.

If the properties of the base paint are found to be not suitable for the formula, preparation device 710 performs process 950 to provide a notice. A notice includes a visual warning, an audible warning, and a communication of information. A visual or an audible warning may be provided to an operator of preparation device 710. A warning may advise the operator that the formula is not suitable for the base paint and that colorants will not be added to the base paint. A notice may further include sending information to a database or a manufacturer that an attempt was made to use a base paint with a formula in an manner that was not suitable. A communication of data may result in a visual or audible warning being provided to a person (e.g., manufacturer, intellectual property rights owner, regulator) other than the operator of preparation device 710.

In another implementation, preparation device 710 electrically couples to data carrier 736 of container 730 to receive information about the base paint in container 730. Preparation device 710 does not receive information about a formula from a data carrier mounted to an object, but from a database. Color formulas may be stored in database 716 or databases 792-796.

A database or a preparation device may protect a proprietary formula by refusing to provide the formula until the recipient has been verified as an authorized recipient of the formula. A database or a preparation device may further verify that the use of the formula is an approved use (e.g., formula used with a suitable base paint).

A manner for a customer to select a paint color stored in a database includes providing a color number, a color shade, a color name, presenting colors on display, and identifying a color card. As set forth above, preparation device 710 uses information about the base paint in container 730 and the formula to determine whether the base paint is suitable for the formula. If the base paint is suitable for the formula, or visa versa, preparation device 710 dispenses colorants according to the formula into container 730. If the base paint is not appropriate for the formula, no colorants are dispensed.

Method 1000 is another implementation of a function performed by preparation device 710. Method 1000 includes processes 1010, 1012, 1020, 1030, 1040, and 1050. Process 1010 includes establishing an electrical coupling between preparation device 710 and data carrier 736 mounted to container 730 as set forth above.

Electrically coupling may include positioning container 730 in such a manner that the conductors of preparation device 710 align and physically contact the electrical conductors of container 730. Electrically coupling may include movement of conductors 732 and 734 to physically contact and electrically couple to the conductors of container 730. Movement of conductors 732 and 734 may be controlled by processing circuit 712. Processing circuit 712 may further control positioning of container 730 or object 750 to accomplish electrical coupling. Processing circuit 712 may control movement and positioning of container 730 or object 750 via control 714.

Process 1012 includes receiving information about the base paint from data carrier 736 via the electrical coupling established in process 1010 as set forth above.

Process 1020 includes receiving information about a color formula. Receiving information includes communicating with a database, providing a display to a consumer, receiving an indication of a selection of a color by a consumer, selecting a color by using a color matching system. Communication with a database may occur over a local bus or via a network as described above. Information communicated to or from a database may include any of the information described herein.

Process 1030 includes using information to determine whether the information received from data carrier 736 of container 730 corresponds to the information about color regardless of the source of the color information.

Correspondence of information may include determining suitability of the base paint of container 730 for a particular color formula as described above. A correspondence may include verification of a source of the information. For example, data carrier 736 may provide a unique identifier or an encrypted value that may be authenticated or verified to establish a correspondence. Failure to authenticate or verify the information results in a failure to correspond. Authentication may be used to protect proprietary formulas as set forth above.

Process 1050 includes adding no colorant to the base paint of container 730. No colorants are added to the base paint because no correspondence is detected between the information provided by data carrier 736 and the formula information regardless of source. Not adding a colorant includes inhibiting the addition of a colorant or taking no action to provide a colorant.

Process 1040 includes adding at least one colorant to the base paint of container 730. A colorant is added to the base paint because a correspondence exits between the information about the base paint and the information about the color formula.

In another implementation, preparation device 710 electrically couples to data carrier 736 of container 730 to receive information from data carrier 736. In this implementation, data carrier 736 provides a unique identifier. Preparation device 710 uses the unique identifier to access (e.g., index) a database (e.g., 716, 792, 794, 796) to receive information about the container. Information received using the unique identifier may include any information disclosed herein including the properties of the base paint contained in container 730.

Color formula information may be received by preparation device 710 in any manner described herein. Data carrier 750 may also provide a unique identifier that may be used to access a database to receive color formula information.

A data carrier that provides only a unique identifier, as opposed to information specific to the object to which the data carrier is attached, may be inexpensively mass-produced thereby achieving a price point at which data carriers may be mounted even on low cost products.

A data carrier that provides only a unique identifier, may include processing circuit 120, memory 122, communication unit 124, and conductors 140 and 142. Memory 122 may be implemented using mask-programmed circuits that store and provide the unique number. Processing circuit 120 may be implemented as a simple state machine that reads the unique number from memory 122 and provides each bit to communication unit 124. Processing circuit 120 may be implemented such that its operation (e.g., number, sequence of states) provide the unique number thereby eliminating memory 122 for additional cost savings. Communication unit 124 may be implemented as described above. Interface 110 may be eliminated because the unique number is stored in memory 122 or programmed into processing circuit 120 at the time of manufacture.

A manufacturer that uses a data carrier that provides only a unique number mounts the data carrier to a product and creates a database that is indexed (e.g., accessed) using the unique number. Information about the product to which the data carrier is mounted is stored in the database.

Using a unique number to access a database permits many parties, not just the manufacturer, to store and retrieve information about the product. Storing only a unique number in the data carrier and creating a database for information related to the unique number reduces manufacturing costs of data carriers and increases flexibility of creating and updating information about the product to which the data carrier is mounted.

In another implementation, dispensing device 710 dispenses a controlled substance (e.g., prescription only drug) into container 730. Dispensing device 710 may perform method 800 to dispense the controlled substance.

Method 800 includes processes 810, 812, 820, 830, 840, and 850. Process 810 includes establishing an electrical coupling between dispensing device 710 and data carrier 736 mounted to container 730 as described above.

Process 812 includes receiving information about the controlled drug for which container 726 has been prepared to contain. Information providing by process 812 may further include an identifier of the person who receive the drug prescription, the medical practitioner who prescribed the drug, number of refills, insurance coverage, co-payment, and a number (e.g., PIN) to identify the authorized recipient. A pin may be programmed into a data carrier during the manufacturing process just as a unique identifier may be programmed.

Process 820 includes receiving information about the identity of the person seeking the controlled substance and/or drugs authorized for dispensing to the person. Information about the person seeking the drug may be provided via a user interface (e.g., number pad, touch screen) (not shown) of dispensing device 710. The information provided by the user may include a PIN, a voice sample, a user identifier, and a biometric sample. Information provided by a user for authentication and/or authorization to receive the controlled substance may be stored in a database and retrieved using information received from data carrier 736 mounted to container 730. Authenticating information may be stored in data carrier 756 mounted to object 750 such that possession of object 750 implies authority to receive the drug. A PIN may still be required even when authenticating information is provided by data carrier 756.

Dispensing device 710 receives the information about the drug, the container, and the user, whether from a data carrier, the user, or a database. Process 830 includes using information to determine whether the information received corresponds. A correspondence includes a container authorized to receive a drug, a user prescribed to receive the drug, and verification of the users identity.

Process 850 includes not dispensing the drug because the information received does not correspond.

Process 840 includes dispensing the drug into container 730 because the information received corresponds.

Dispensing into an identified container provides an opportunity prior to dispensing for a medical practitioner to properly label the container for the type of drug, dosage, use, and permitted user.

Dispensing system 700 may use data carriers that provide a unique identifier and a database to store and provide information related to the unique identifier.

A container that includes a data carrier mounted to the container may be the basis of a recycling scheme that encourages recycling of containers and any chemical contained in the container by using financial incentives. For example, recycling system 1100 includes container manufacture 1140, chemical manufacture 1150, recycler 1160, vendor 1170, chemical user 1190, vendor 1180, database 1120, network 1130, and financial institution 1110.

A container manufacture manufactures containers having at least one data carrier mounted to each container. Information about the container is stored in database 1120. The information about each container may also be stored in the data carrier mounted to the container. Information in database 1120 is indexed by a unique container identifier (e.g., serial number, alpha-numeric number) stored in the data carrier mounted to the container, thus the minimum information stored in the data carrier is the unique identifier. The manufacture stores in the database, and possibly the data carrier, any information disclosed herein that is accessible to the manufacturer.

The manufacture accesses database 1120 via data network 1130. Database 1120 may be implemented in any manner including the implementations discussed herein. Database 1120 may be maintained by container manufacturer 1140, chemical manufacturer 1150, recycler 1160, vendor 1180, vendor 1170, a regulatory agency, or any combination of these entities. Each entity that uses or is required to use system 1100 may be required to pay a fee to maintain database 1120. Database 1120 may also be supported by interest payments on undisbursed fees and deposits paid to financial institution 1110.

Data network 1130 provides access to database 1120. Data network 1130 includes any conventional network.

Distribution network 1130 is a network by which goods, products, containers, chemicals, and money are distributed throughout a region (e.g., the U.S.). A distribution network may include warehouses, transportation companies, personnel, and computer systems for distributing and selling goods.

Transfer of a container may occur directly from container manufacturer 1140 to chemical manufacture 1150 or to any purchaser via distribution network 1130. Upon transfer, container manufacture 1140 creates or updates database 1120 for the container.

Upon transfer of the container, container manufacturer 1140 may be required to pay the cost of recycling the container in the form of a recycling fee. The recycling fee is transferred to financial institution 1110 where it is held until the container is recycled.

Chemical manufacturer 1150 receives a container and fills it with a chemical. The implementations described above include base paints and controlled substances; however, recycling system 1100 operates to motivate recycling of any type of container or other object to which a data carrier is mounted. When chemical manufacturer 1150 moves the container containing the chemical into the stream of commerce or any other type or transfer, chemical manufacturer 1150 updates database 1120 with the information known to the chemical manufacture which may include any of the information described herein. Chemical manufacturer 1150 at least provides information related to the chemical contained by the container. Chemical manufacturer 1150 access database 1120 using the unique identifier stored in the data carrier mounted to the container.

Upon transfer of the container with the chemical (e.g., into distribution network 1130), chemical manufacturer 1150 may be required to pay a chemical recycling fee. The fee may be equivalent to the cost of recycling the chemical in the container. If the chemical is such that no recycling is required (e.g., water), no fee may be required. If the chemical is highly toxic, chemical manufacturer 1150 may be required to pay the recycling fee and to provide additional information to database 1120. Additional information may include the identity of the entity that is receiving the container with the chemical. Database 1120 may be used to track a chain of custody of containers that contain toxic or harmful substances.

A chain of custody may include the identity of a provider, a receiver, and a user of the chemical. Registration of providers, receivers, and users may be required. Authentication of registration may be required prior to transfer or use. Consumers may be required to register.

The recycling fee from chemical manufacture 1150 is transfer to financial institution 1110 and kept on deposit until the chemical is recycled. Recycling fees for containers in which the chemical is completely consumed may permit reimbursement of all or a portion of the recycling fee to chemical manufacturer 1150 instead of payment to recycler 1160 to recycle a now non-existent chemical.

Vendors 1170 and 1180 sell the chemicals produced by chemical manufacturer 1150. In this implementation, vendor 1170 does not have a business relationship with vendor 1180. Indeed, vendors 1170 and 1180 may be competitors. Vendors 1170 and 1180 may also sell chemicals from other chemical manufactures (not shown). Vendors 1170 and 1180 may sell some products from common manufactures and products from different manufacturers. Vendors 1170 and 1180 may sell the same type of chemicals (e.g., paints, thinners), but from different chemical manufacturers.

Chemical user 1190 uses the chemicals manufactured by chemical manufacturer 1150. In this example, chemical user 1190 uses the chemicals produced by chemical manufacturer 1150 in small quantities and cannot purchase directly from chemical manufacturer 1150, thus chemical user 1190 must purchase chemicals from vendors 1170 or 1180.

When chemical user 1190 purchase a container of chemicals from vendor 1180, vendor 1180 determines that chemical user 1190 will consume, and not resell, the chemical, so vendor 1180 charges chemical user 1190 a container deposit. The container deposit should be of an amount sufficient to motivate chemical user 1190 to return the container to receive reimbursement of the container deposit. The container deposit fee may include the container and chemical recycling fees thereby relieving container manufacturer 1140 and chemical manufacturer 1150 from paying the recycling fees; however, any recycling fees would need to be deducted from the container deposit fee prior to reimbursement.

Because the container containing the chemical includes a data carrier, the information from the data carrier may be used to perform any additional preparation (e.g., tint a base paint) of the chemical to meet the needs of chemical user 1190.

Upon transfer of the container to chemical user 1190, vendor 1180 updates database 1120 with information about the transfer including any information disclosed herein that is known to vendor 1180 or possibly chemical user 1190. Vendor 1180 transfers the deposit fee to financial institution 1110.

Once chemical user 1190 finishes using the chemical in the container, the chemical user may wish to discard the container. If the container deposit fee is sufficiently high, the user, or another person who obtains possession of the container, will be motivated to meet the requirements to receive reimbursement of the container deposit fee.

Centralized database 1120 and financial institution 1110 increase the flexibility of returning containers and receiving a rebate of the container deposit. Because vendor 1180 did not retain the container deposit paid by chemical user 1190, chemical user 1190 does not need to return the container to vendor 1180 to receive the deposit. Chemical user 1190 may return the container to any vendor that has access to database 1120 and financial institution 1110.

In this implementation, chemical user 1190 returns the container, with or without the chemical, to vendor 1170 even though vendor 1170 did not sell the container or receive the deposit. Upon receipt of the container, vendor 1170 electrically couples to the container to receive the unique container identifier. Vendor 1170 verifies that a deposit was paid for the container, pays the person returning the container the deposit fee, and requests reimbursement from financial institution 1110. Vendor 1170 also updates database 1120 to show the return of the container, disbursement of the container fee, and any other information available to vendor 1170.

Recycling system 1100 permits a chemical user may purchase chemicals from a vendor that offers the best price, yet return the container to and receive reimbursement from the vendor that provides the highest convenience (e.g., located close to chemical user) for returning the container. A system having database 1120 and financial institution 1110 enables any vendor to collect and any another vendor to reimburse the container deposit fee without being financially harmed by receiving a container.

In the event that a container is damage such that the data carrier cannot provide the unique container identifier, no deposit need be paid; however, law may still required the receiving entity (e.g., vendors 1170, vendor 1180) to receive the container and send it to recycler 1160 for recycling. Financial arrangements may be made in any manner to pay a receiving entity and recycler 1160 for containers that cannot be identified.

The vendor that receives a container, in this case vendor 1170, sends the container either directly or via distribution network 1130 to recycler 1160. To protect against fraud, financial institution 1110 may withhold reimbursement of the container deposit fee to the receiving vendor until receipt of the container is verified via updating database 1120 by recycler 1160.

Upon receipt of the container, recycler 1160 updates database 1120 with the information known to recycler 1120. Recycler 1120 requests payment of the fees for recycling the container and/or the chemical and recycles the container and/or the chemical.

A financial institution includes any entity that receives, accounts for, and disburses money. A financial institution may receive, hold, and disburse funds as containers are sold and returned. A financial institution includes a bank, a government agency, an industry coalition, a vendor, or any combination thereof. A plurality of financial institutions may provide the services describe herein. A user of the financial services may select a financial institution from the plurality of financial institutions. A selection criteria may include the cost of the services provided by the institution.

Recycling system 1100 may be implemented in such a manner as to charge only one container deposit for each container. A deposit may be charged at any point in distribution network 1130. In one implementation, only the entity that uses the chemical is charged the container deposit because that entity is the most likely to have control of the container when it is empty or partially empty and ready for recycling.

A system used by a vendor or a distributor may perform method 1200 to determine whether to collect a container deposit and what type of information to provide to database 1120. Method 1200 includes processes 1210, 1220-1224, 1230-1232, and 1240-1242.

Process 1210 includes determining the purpose of the sale or the proposed use by the purchaser. A purpose for a sale includes using the chemical in the container and reselling the chemical. Information about the purpose of the sale may be provided by the purchaser. A purchase for resale executes processes 1230-1232. A purchase for use executes processes 1220-1224.

Process 1220 and 1230 includes detecting the unique identifier of the container as set forth above. Detecting a unique identifier includes electrically coupling to the container and receiving the identifier via the conductors of a data carrier as described above.

Process 1222 includes receiving the container deposit. Receiving includes receiving payment of the container deposit in any conventional manner (e.g., credit card, cash, store credit). Process 1224 includes transferring the container deposit to financial institution 1110. The container deposit may be transferred from a vendor to financial institution 1110 in any conventional manner (e.g., wire transfer, mail, bank transfer, check, credit).

Process 1232 includes receiving an identifier of the vendor receiving the container of chemicals for resale. Process 1240 includes receiving an identifier of the vendor that is transferring the container of chemical to either a user or a reseller. Collecting information about a vendor that purchases for resell and the vendor that sells for either use or resale permits database 1120 to maintain a chain of custody as describe above. An identity (e.g., identifier) of a receiving or transferring vendor may be provided by the vendor.

Process 1242 includes updating database 1120 with the information about the transfer as described above.

The foregoing description discusses preferred embodiments of the present invention, which may be changed or modified without departing from the scope of the present invention as defined in the claims. The examples listed in parentheses may be alternative or combined in any manner. The invention includes any practical combination of the structures and method steps disclosed. While for the sake of clarity of description several specifics embodiments of the invention have been described, the scope of the invention is intended to be measured by the claims as set forth below.

What is claimed is:

1. A method performed by an apparatus for preparing a chemical composition, the method comprising:
electrically coupling to a first electrical conductor of a first data carrier;
receiving via the first conductor indicia of a property of a chemical;
electrically coupling to a second electrical conductor of a second data carrier;
receiving via the second conductor a formula for the chemical composition; and
detecting whether the property of the chemical is suitable for preparing the chemical composition; wherein:
the first data carrier is mounted to a container that contains the chemical;
the first data carrier stores indicia of the property of the chemical; and
the second data carrier is mounted to an object.

2. The method of claim 1 wherein the object that displays a presentation of a property of the chemical composition.

3. The method of claim 1 further comprising:
responsive to detecting, dispensing a second chemical into the container to prepare the chemical composition.

4. The method of claim 1 further comprising:
responsive to detecting, halting preparation of the chemical composition because the property of the chemical is not suitable for the chemical composition.

5. The method of claim 4 wherein:
the property of the chemical comprises a manufacturer identifier of the chemical;
the formula comprises a manufacturer identifier of the formula; and
the property of the chemical is not suitable for the chemical composition because the manufacturer identifier of the chemical is different from the manufacture identifier of the formula.

6. The method of claim 1 wherein the property of the chemical is suitable because a manufacturer identifier of the chemical matches a manufacturer identifier of the formula.

7. The method of claim 1 wherein receiving via the conductor comprises providing a signal for modulation by the data carrier.

8. The method of claim 1 wherein detecting comprises detecting a correspondence between a property of a base paint and a color formula.

9. A method performed by a tinting device for providing colorants to a container containing a base paint, the method comprising:
electrically and physically coupling to the container to receive a first information about the base paint;
receiving a second information about a formula for preparing a paint color;
detecting whether the first information corresponds to the second information; and
in accordance with detecting, providing zero or more colorants to the container.

10. The method of claim 9 further comprising receiving a third information, wherein the third information comprises a least one of a method of application, an environmental condition, and a method of curing.

11. The method of claim 9 wherein at least one of the first information and the second information comprises a manufacturer identifier.

12. The method of claim 9 wherein at least one of the first information and the second information comprises a unique identifier.

13. The method of claim 9 wherein the second information comprises a color formula.

14. The method of claim 9 wherein a correspondence comprises a match between a data of the first information and a data of the second information.

15. The method of claim 9 wherein detecting comprises comparing a manufacturer identifier of the base paint to a manufacturer identifier of the formula.

16. The method of claim 9 wherein a correspondence comprises a match between a manufacturer identifier of the base paint and a manufacturer identifier of the formula.

17. A tinting device for tinting a base paint, the tinting device for cooperating with a provided container that contains the base paint and a provided color card, the tinting device comprising:
a first electrical connector;
a second electrical connector; and
a processing circuit; wherein:
the first connector electrically couples to a first provided conductor mounted to the container;
the second connector electrically couples to a second provided conductor mounted to the color card;
the processing circuit receives indicia of a property of the base paint from the container via the first conductor;
the processing circuit receives indicia of a formula of a color from the color card via the second conductor;
in accordance with the property of the base paint and the formula, the processing circuit provides a signal to a provided colorant dispenser to dispense zero or more colorants into the container.

18. The tinting device of claim 17 wherein the circuit:
provides a carrier to the first connector; and
detects a modulation of the carrier to receive indicia of the property of the base paint.

19. The tinting device of claim 17 wherein the circuit:
provides a carrier to the second connector; and
detects a modulation of the carrier to receive indicia of the second property.

20. A method performed by a dispensing device for providing a chemical to a container, the method comprising:
electrically and physically coupling to a data carrier mounted to the container, the container for receiving the chemical and the data carrier for providing a first information;
receiving a second information from a user;
detecting whether the first information corresponds to the second information; and
in accordance with detecting, dispensing the chemical into the container.

21. The method of claim 20 wherein:
the first information comprises a description of the chemical;
the second information comprises a user identifier.

22. The method of claim 20 wherein the first information comprises:
a description of the chemical; and
a number of remaining refills of the container.

23. The method of claim 20 wherein receiving comprises electrically and physically coupling to a second data carrier mounted to an object provided by the user; wherein:
the second data carrier provides the second information.
